(19) United States
(12) Patent Application Publication
(10) Pub. No.: US 2004/0220876 A1
(43) Pub. Date: Nov. 4, 2004

(54) Systems and methods for services over a financial transaction platform

(76) Inventor: David J. Liu, Santa Barbara, CA (US)

Correspondence Address: WINSTON & STRAWN, PATENT DEPARTMENT, 1400 L STREET, N.W., WASHINGTON, DC, 20005-3502, US

(21) Appl. No.: 10/428,699

(22) Filed: May 2, 2003

(51) Int. Cl. G06F 17/60

(52) U.S. Cl. 705/44

(57) ABSTRACT

Beneficial services such as a pay stub service, a tax document service, or a messaging service may be provided on a financial services platform such as an automated teller machine network services platform. The edge-connections of a financial services network that is part of the platform may be terminals that are publicly accessible, designated for public use, and/or dispersed over a wide area. Automated authorization checking for determining whether beneficial use may be gained may be implemented. Benefits such as the presentation of information via display or printout may be provided. The content of the benefit may be one that is sought to be delivered by a third party other then financial institution of the current user.

### BACKGROUND OF THE INVENTION

The present invention is related to communications network services, and more particularly, to financial services communications networks.

It has been found that conventional technology does not adequately meet some of today's personal communications needs. One platform for performing a wide range of activities that is in wide spread use today is the Internet. The Internet, however, has certain drawbacks that make its use inconvenient or unsuitable for some commercial or information distribution activities. For example, security has always been a concern with respect to communications on the Internet.

Throughout the years, substantial efforts towards development of software or hardware security measures have been pursued at great expenditures to the companies. Various security protections such as virtual networks, firewalls, encryption, etc. have been developed to aid in system integrity and security in the Internet context. Some of these measures are pursued in general because there is insufficient control over the edges of the network such as the who, where, what, or when of network use. Another drawback that is sometimes faced in this type of network is that user-access is typically through private points of access (e.g., limited to the owner of the access device or agents or associates thereof). For example, most often individual users “surf” the Internet through their own personal computer at home or at work. Outside of the work or home environment, a user typically has insufficient or inconvenient access to be able to use the network. Using someone else's computer may involve entering sensitive information in that person's computer, which may be undesirable. On the other hand, many users may not even want to make their personal computer available for someone else's use because their computer may hold their personal or private information which they wish keep protected. There are some publicly accessible Internet access sites (e.g., Internet cafes, public kiosks) that are designated as such. In most such sites, there is little protection provided against a subsequent user or the operator of the equipment finding user information of others.

Another drawback is there is a segment of the public that is not familiar or comfortable with Internet interface software or hardware, which if given the preference would choose more familiar technique. In addition to or as part of these issues, there is a deficiency in that in some circumstances it is desirable to authenticate or obtain the identity of a user before beneficial network resources are made available.

One type of service that does not appear to be adequately served by Internet type applications is in the field of personal, private, or financially sensitive communications with pay stub delivery services being a typical example. Conventional pay stub delivery services are known to adequately provide their services for all segments of pay stub recipients. Conventional pay stub technology involves the printing and distribution, via mail or by hand, of pay stubs by an employer or by a company hired by the employer. Such a process often involves printing large batches of pay stubs on a weekly, biweekly, or monthly basis, which can be expensive and time consuming. In addition, preparation of such stubs for distribution in a certain manner is typically required in order to try to maintain confidential the personal and private information contained therein. Personal or mail delivery may also add to the expense and production time of the service. Existing systems may for example be unsuitable for delivery to an employee who does not have an address or is a transient because delivery by hand or mail to the employee or former employee may be difficult. Using a network such as the Internet may be an inadequate solution for such services at least because of the drawbacks that were discussed above with respect to the use of the Internet for personal or private communications.

The present invention now overcomes the drawbacks of using the internet for delivery of confidential financial documents while maintaining the confidentiality of such documents.

### SUMMARY OF THE INVENTION

In accordance with the principles of the present invention, systems and methods are provided for add-on services on a financial transaction platform. A wide area financial services network such as an ATM network may be adapted to deliver specialized (e.g., non-ATM or POS) services to network users (e.g., users of ATMs or POS terminals). The special services may be provided through the implementation of service or message facilities.

Financial services terminals such as ATMs or POS terminals may provide access to the special services. The special services may include a pay stub services, tax document services, e-mail services, or other services where, for example, third party (e.g., someone other than the financial institution that is offering their financial services through the network to users who have an account with that financial institution) seeks to deliver content or services to an individual who has access to the financial services network. Financial services terminals may be implemented to be widely dispersed, to be conveniently located (e.g., publicly accessible), to automatically check for authorization, to be controlled or owned by providers of financial services, to have a mechanism for charging for services rendered, to have a user interface that is typically well know, standardized, or simple to understand.

Various structures for implementing such systems and methods are disclosed. The message facility may be implemented as part of the financial services equipment of a financial institution, implemented as a stand alone facility, or implemented in a combination thereof.

Messages or packets for the special service may be routed through the infrastructure of the financial services network (e.g., through its routers) to request and deliver the benefit of the service to a user. Beneficial interaction with a current user may proceed in response to receiving access information such as account information or a personal authorization numbers, which may have been issued, assigned, or given to a user by a financial institution at which the user has established a financial account such as a money deposit account or a credit account.

A user may be presented with a benefit of the service at a financial services terminal with which the user is interacting. A user may be presented with information displayed to the user via a display device at the financial services terminal or presented with a print-out generated at the financial services terminal.

A pay stub service may be provided in which an employer can deliver pay stub information to an employee. The pay stub information may be presented in a printout or a display and may include pay stub information such as salary, withholdings, deductions, totals, relevant dates, or other pay stab type information. The pay stub service may deliver pay stub information over the financial services platform so that an employer can conveniently and cost effectively deliver such information and an employee can collect the information from communications network access points, which may be desirably dispersed and secured. Tax documents or tax information may also be delivered in substantially the same way.

Another service may be an e-mail service. With such a service, an e-mail account or services may be given to those who have access to a financial services network. Users may be given the opportunity to view message lists, messages, or other related information while using the financial services platform. A message or message list may be presented at a financial services terminal which may be presented with information identifying the message (e.g., from, whom, sent, subject, etc.) or content information (e.g., the body of the message).

### BRIEF DESCRIPTION OF THE DRAWINGS

Further features of the invention, its nature and various advantages will be more apparent from the following detailed description, taken in conjunction with the accompanying drawings in which like reference characters refer to like parts throughout, and in which:

FIG. 1 is a diagram of an illustrative system in accordance with one embodiment of the present invention;

FIG. 2 is a diagram of an illustrative system having ATMs and POS terminals for service terminals in accordance with one embodiment of the present invention;

FIG. 3 is a flow chart of illustrative steps involved in providing services in accordance with one embodiment of the present invention;

FIG. 4 is a flow chart of illustrative steps involved in providing services in an automated teller machine communications network in accordance with one embodiment of the present invention;

FIG. 5 is a flow chart of illustrative steps involved in delivering services from a third party on a financial transaction platform in accordance with one embodiment of the present invention;

FIGS. 6-11 are diagrams of interactive display screens for providing a special service such as a pay stub service in accordance with one embodiment of the present invention;

FIG. 12 is a diagram of a pay stub printout from a financial service terminal in accordance with one embodiment of the present invention;

FIG. 13 is a diagram of a financial tax document personated in accordance with one embodiment of the present invention;

FIG. 14 is a diagram of an illustrative message list in accordance with one embodiment of the present invention; and

FIG. 15 is a diagram of an illustrative message in accordance with one embodiment of the present invention.

### DETAILED DESCRIPTION OF PREFERRED EMBODIMENTS

A wide area financial services network such as an automated teller machine (“ATM”) network may be adapted to provide specific services such as pay stub services to users of financial services terminals such as ATMs and point of sale (“POS”) terminals. The specific service may be one that rides on the financial services platform to incorporate the conveniences such as terminals designated for use by the public, the ease of use of a basic and well-known user interface, the protection of automated identify verification (e.g., through established and accepted means such as an ATM card and a PIN), etc.

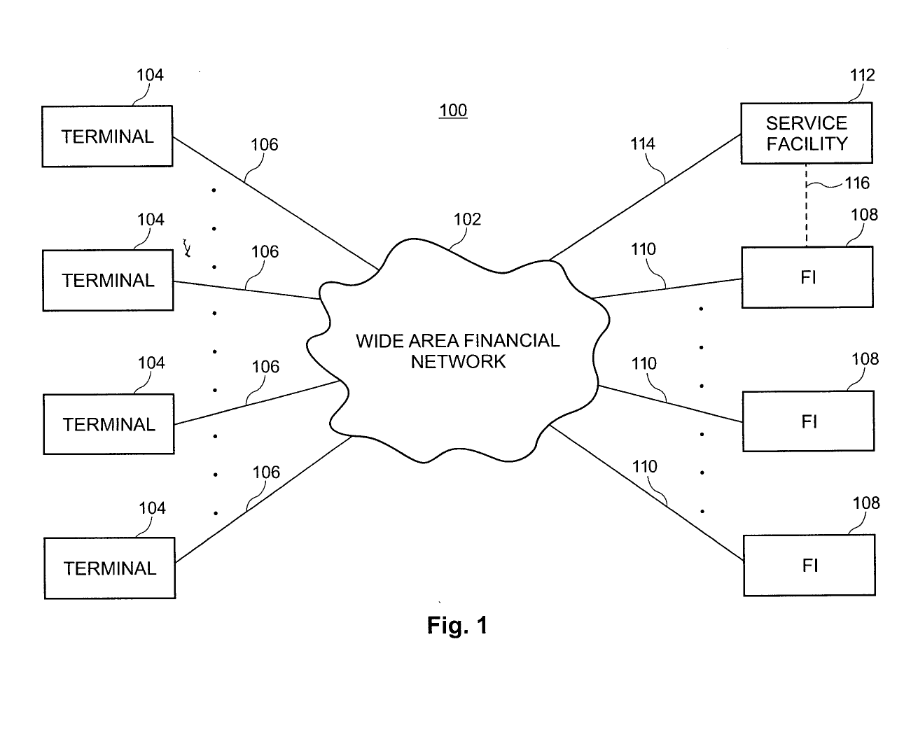

With reference now to FIG. 1, system 100 may include wide area financial services network 102, financial services terminals 104, communications links 106, financial institutions 108, communications links 110, and service facility 112, communications link 114.

Wide area financial services network 102 may be a wide area network that is established with infrastructure and communications protocols that are primarily dedicated (e.g., entirely dedicated) and/or developed (e.g., only developed) for providing financial services, which are offered by financial institutions to their customers. Financial services may be offered to users at terminals 104. Terminals 104 may be installations that are publicly accessible and are publicly-designated to offer financial services. Terminals 104 may be hosted by a financial institution or other financial services provider and if desired may not be for individual or personal use or possession. Communications links 106 may be telephone communications links or other communications links (wired, wireless, or combinations thereof).

A financial institution offering financial services over network 102 may have financial institution facilities 108. Facilities 108 may have sufficient processing and storage equipment to handle financial service requests of their customers. Communications links 110 should typically be high bandwidth communications links, wired links, wireless links, or combinations thereof for handling financial services interactions with network 102 and/or terminals 104. Service facility 112 may be charged with providing a particular service over network 102 such as to provide a pay stub service, a messaging service, a third party service, a tax document service, a service that is a ride-on to the financial services offered by the financial institution, or other personal (e.g., personal finance) related service. For convenience, the terms messaging service or special service are sometimes used herein to avoid having to specifically name an array of service embodiments which may have some common characteristics but may potentially also have widely disparate characteristics.

Service facility 112 may communicate with network 102 via communications link 114, which may typically be a high bandwidth communications connection, which may comprise communications that is wired, wireless, or combinations thereof. Financial institution facilities 108 and terminals 104 may communicate with service facility 112 via network 102. If desired, communications link 116 may be implemented to provide a point-to-point or dedicated communications link between service facility 112 and financial institution facility 108. For simplicity, only one of facilities 112 is shown with link 116. In application, more than one link may be provided. If desired, communications between service facility 112 and financial institutions 108 may be through a network that is separate from network 102 (e.g., communications sent between facility 112 and financial institutions 108 would not be carried over network 102).

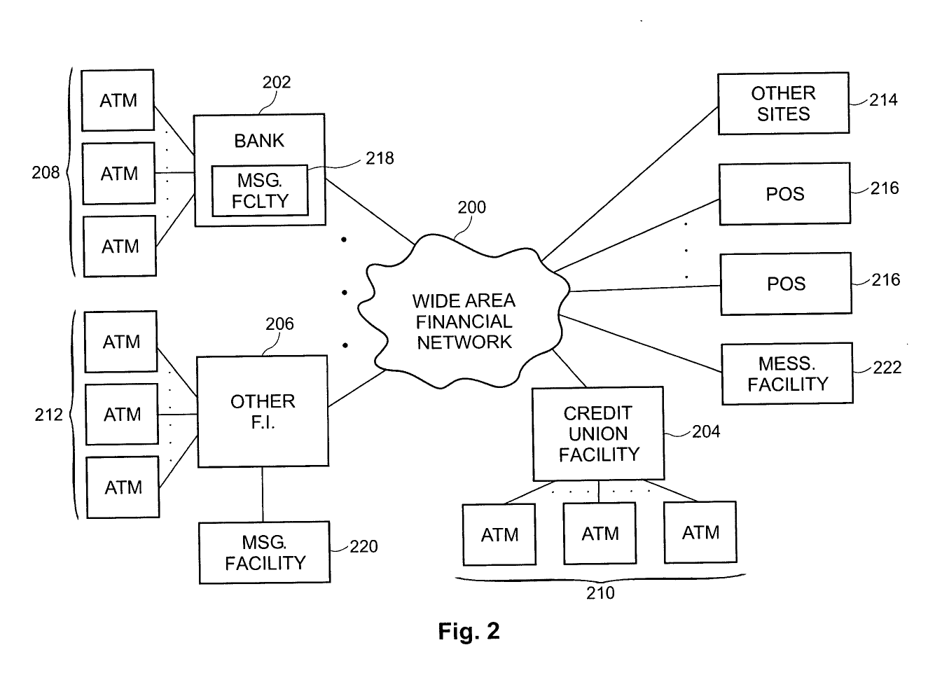

An ATM communications network may be adapted to provide the messaging or special services. With reference now to FIG. 2, wide area financial services network 200 may be an ATM network or other network having pertinent characteristics common with an ATM networks. ATM networks are known to those skilled in art and are a part of existing banking infrastructures for the offering of networked automated banking services to customers. Conmunications standards (such as an ANSI communications standard) and communications switches for routing messaging meeting the standards have been developed and implemented to provide such networks. Commonality in interfaces and communications used in such networks has been approached. Financial institutions such as banks, credit unions, or other financial institutions may set up facilities such as bank facility 202, credit union facility 204, and other financial institution facility 206 (if any) that are configured to support the financial services offerings of those financial institutions in network 200 for their respective customers. Although only one bank facility 202, credit union facility 204, and other financial institution facility is shown, the system may be implemented with a plurality of such facilities.

Bank ATMs 208 may be installed for public use by a bank that is associated with bank facility 202. Bank ATMs 208 may have a communications connection with bank facility to support financial service offerings of the bank for that bank's customers. In this arrangement, the bank, which is associated with bank facility 202 and bank ATMs 208, may configure its bank facility 202 and bank ATMs 208 to specifically offer financial interactions to their customers which may include ATM service interactions and other local financial service interactions (e.g., services incompatible with or unavailable for communications over network 200) such as an account history presentation that the bank may provide through their local hardware or software installations. The bank may have its own network that is separate from network 200 for supporting its ATMs and bank facilities. As shown, credit union facility 204/credit union ATMs 210 and other financial institution facility 206/ATMs 212 may be configured with similar arrangements.

ATM traffic is typically carried by network 200 and routed using ATM switches in network 200 to an appropriate destination when a user interacts with an ATM offered for use by one financial institution to obtain the benefit of a financial service offered (e.g. a debit request for a withdrawal or a balance request) by a different financial institution with which the current user has a pre-existing financial relationship such as a cash deposit account or credit account. Other sites 214 may be representative of other types of financial services terminals such as ATMs that are installed by companies whose service is to provide ATMs at convenient locations such as convenience stores for a flat fee (e.g., a flat-per-transaction fee). Techniques for providing such other sites (e.g., through the use of concentrators) are known to those skilled in the art.

Point-of-sale systems 216 may include POS terminals with which shoppers at a store (e.g., a retail store, a grocery store, etc.) may interact to perform an ATM transaction such as to pay for goods or services from a cash deposit (e.g., checking account) at their financial institution. Conventional POS systems are typically configured to execute a variety of other types of payments such credit card payments, check payment, cash tender payment, etc.

A message facility or special service facility may be implemented in a variety of ways. Some of such techniques are shown together in FIG. 2. If desired, only one of these technique types or combinations of these techniques types may be implemented. The types of technique encompass variations which a message facility is implemented as part of the hardware and/or software of a facility of a financial institution (e.g., message facility 218 implemented in bank facility 202), implemented as a separate standalone facility that has a communications connection with a facility of a financial institution (e.g. message facility 220 connected to other financial institution facility 206), or implemented as a separate standalone facility that communicates with financial services terminals through an ATM network (e.g., message facility 222). Techniques for establishing the various communications connection are known to those skilled in the art. Message facility 220 may be implemented without having its own (e.g., separate) communications connection with network 220. Message facilities 218, 220, or 222 may be implemented to provide their services to financial services terminals across network 200. A message facility such as message facility 218, 220, or 222 may be implemented to provide network-wide services through its communications connection with network 200. For example, if an implementation such as that shown in connection with message facility 218 or 220 is provided, that implementation may be configured to not only serve ATMs 208 or 212 but also other terminals such as ATMs 210. Thus, services associated with message facilities 218, 220, or 222 may be provided on a platform that has widely dispersed and convenient outlets for the services and, which provide characteristics (e.g., automated user identification) that are particularly suited for those services.

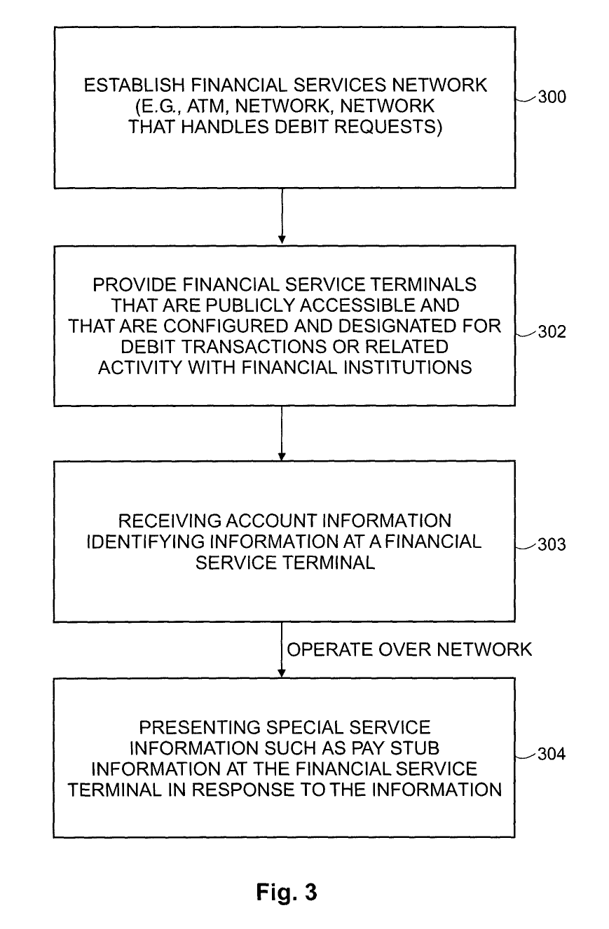

Illustrative steps that may be involved in providing message or special services to users based on user network access information (e.g., such as information that has been issued to a user by their bank) are shown in FIG. 3. At step 300, a financial services network may be established. The financial services network may for example be a network for carrying financial services or transaction activity (e.g., a network dedicated to carrying financial services or transaction activity). At step 302, financial services terminals may be provided to use of the financial services network. The financial services terminals may be configured and designated (e.g., designated to the public) for debit transactions or related activity (e.g., balance requests) with financial institutions.

At step 303, account information may be received at a financial services terminal from a current user of the terminal. The account information may be information that is representative of or that identifies the current user's financial account at a financial institution. In addition to or separate from the account information, financial institution information may be received that provides information that is representative of or identifies the financial institution that is associated with the account. The systems and method herein are typically performed with multiple financial services terminals to service a plurality of users. The financial services terminals may have hardware and/or software configured to receive the information from a current user. Various techniques may be implemented to receive the information at financial services terminals. For examples, if users have been issued cards for use of the network, card insertion or card swiping may be used to receive the account information. Other techniques may involve the use of wireless transmitters in a user-carried device that can send the information to the financial services terminal. Other forms of card reading or signal transmission techniques may also be employed. One advantage of such techniques over Internet techniques may be that a user is not required to personally or enter an electronic address in order to access desired services.

The account information may be considered one part of a key that gives the key holder access to beneficial use of the financial services terminal. The second part of the key may be a personal authentication information such as a personal identification number that is associated with the first part of the key and for security purposes is typically not available from the physical source from which the first part of the key is received by a financial services terminal.

In response to the account information or in response to the account information and personal authentication information, the financial services terminal may communicate over the financial services network, for example, to send the information for verification, to deliver user-services to the current user, or to configure the terminal for the current user. At step 304, special service information such as pay stub information may be presented to the current user in response to the account information (e.g., account number information, financial institution information, other account information, or combinations thereof) or in response to the account information and authentication information. Thus, an individual may for example be presented with their pay stub (e.g., in a display device or printout) through the delivery of the pay stub via a financial services network (e.g., network 200 of FIG. 2) to a financial services terminal that the individual is currently using. Another special service may be the delivery of tax documents such as W-2 forms.

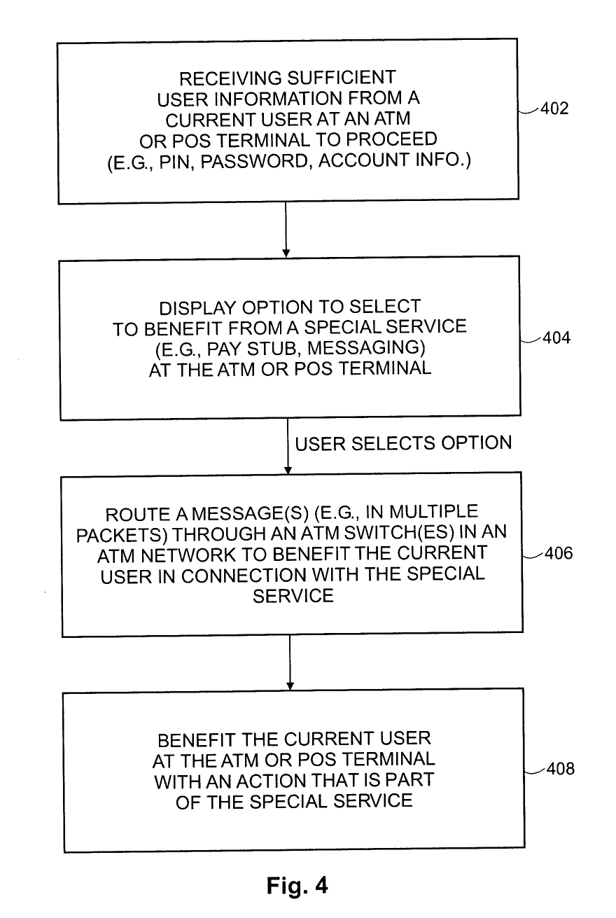

Illustrative steps involved in providing a benefit of a special service via an ATM network are shown in FIG. 4. At step 402, an ATM or a terminal in a POS system having ATM capabilities may receive sufficient user information from a user at an ATM or POS terminal to proceed with service interactions. A user may provide their account information (e.g., by swiping their ATM card) and may also provide (e.g., enter) their personal identification number to open user-access to services, which may available through the ATM or POS terminal. At step 404, the ATM or POS terminal may display an option that the user may select to benefit from a special service such as a service that is in addition to and/or different from conventional ATM or POS terminal services such as cash withdrawal and balance inquiry (e.g., a pay stub service or a message service). A message, or multiple messages, may be sent and routed through ATM switches that are part of the routing infrastructure of the ATM network to an appropriate destination to provide the benefit of the special service to the current user at step 406 in response to the user selecting the option. The message or messages may be sent over the network as a debit request having particular details therein to permit its handling by destination equipment. If the standard packet size of the network is not of sufficient size to handle the routing of desired content in step 406, multiple packets may be employed (e.g., a pay stub may be sent in multiple or separate network packets).

At step 408, the current user may be benefited at the ATM or POS terminal with an action that is part of the special service when appropriate content is routed over the ATM network to the ATM or POS terminal. For convenience, only a single user is mentioned in connection with FIG. 4. However, such techniques may be implemented to provide network-wide services. The ATMs or POS terminals may be existing terminals which were designated and installed for the delivery of ATM or POS services before the implementation of the special service. The ATMs, POS system terminals, or other such terminals in an ATM network have the benefit of providing secure edge-connections for the network. Thus, ATM networks, ATMs, or POS systems may provide added benefits to users.

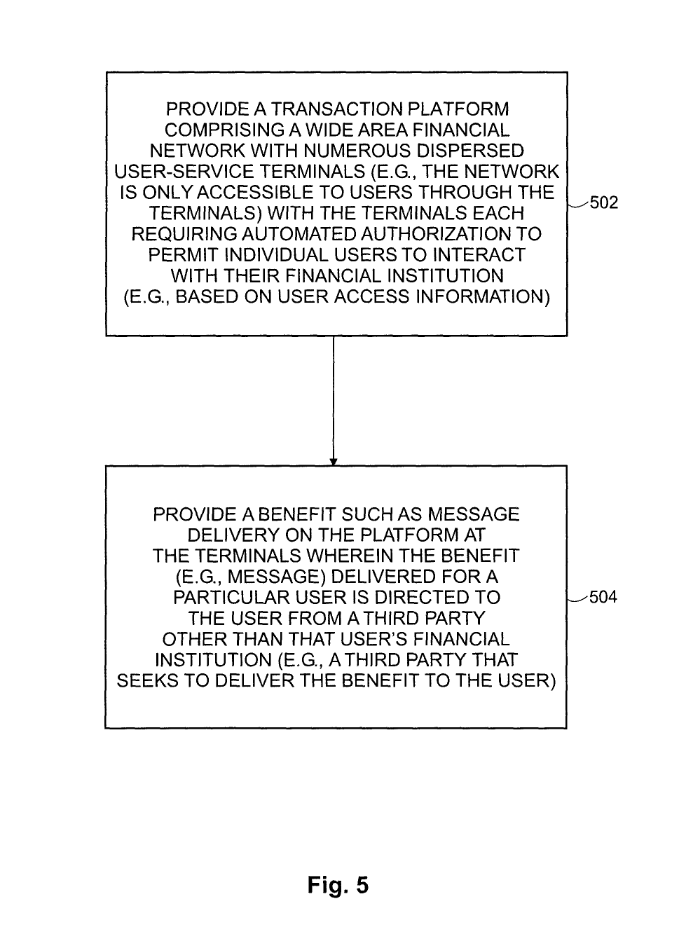

Illustrative steps involved in identity-authenticated message services for messages between customers of financial institutions and third parties are shown in FIG. 5. At step 502, a transaction platform that includes a wide area financial services network with numerous dispersed user-financial-services terminals (e.g., the network is only accessible to users through the terminals). The terminals in the wide area financial services network may be configured to each require automated user-authentication to permit individual users to interact with their financial institution (e.g., a financial institution that is remotely located from the terminal that a user is currently using) to obtain beneficial services.

At step 504, message delivery or other benefit may be provided on the transaction platform at the terminals, wherein the message or other benefit that is delivered for a particular user (e.g., any user) is directed to the user from a third party other than that user's financial institution (e.g., the financial institution that gave the user sufficient rights to use the financial services network). The benefit that is delivered may be one that originates from the third party and/or may be a benefit that the third party is seeking to have delivered to a particular user.

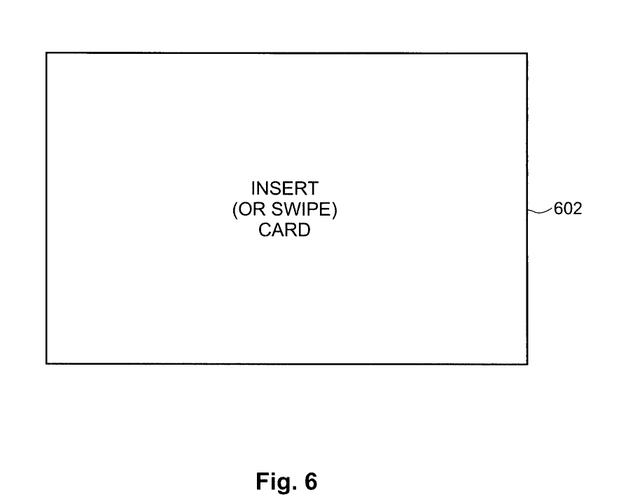

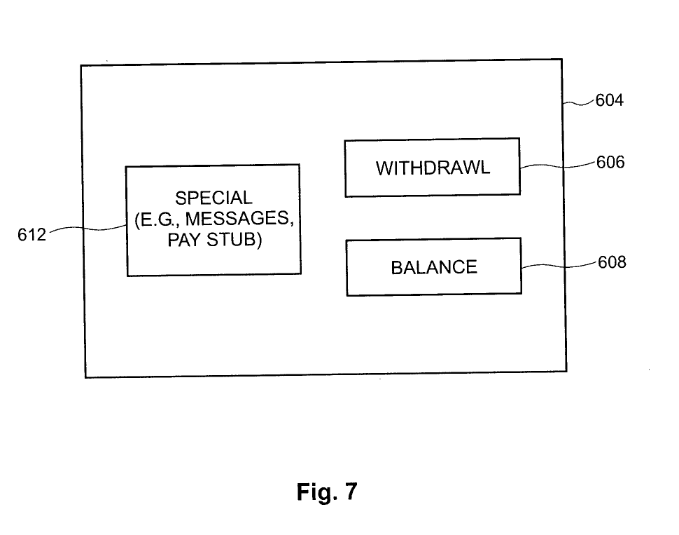

Illustrative special service related presentations according to some embodiments of the present invention are shown in FIGS. 6-15. The presentations are primarily provided in the ATM context. However, they may be applicable to different types of terminals with possibly different formatting or in other financial services context. Introductory display screen 602 of FIG. 6 may be presented by a display device of a financial services terminal to prompt a user to insert (or swipe) their ATM card into a card reading device of the terminal so that the account information may be received. Other prompts for receiving account information in other ways may also be presented. FIG. 7 illustratively shows services display screen 602 that may be displayed by the terminal in response to receiving account information and if desired, in response to receiving personal authentication information (e.g., a PIN). Personal authentication information may be requested and received by a current terminal initially when the current user approaches the current terminal or it may be requested and received at one or more various points during user-terminal interactions. Display screen 604 may include options for conventional ATM services such as withdrawal option 606 and balance option 608. Display screen 604 may also include special service option 612. Special service option 612 may include text identifying the special service (e.g., pay stub, messaging, etc.). If desired, special service option 612 may be displayed when the terminal has received a trigger or other information (e.g., from the ATM card of current user) that indicates that the service option should be displayed.

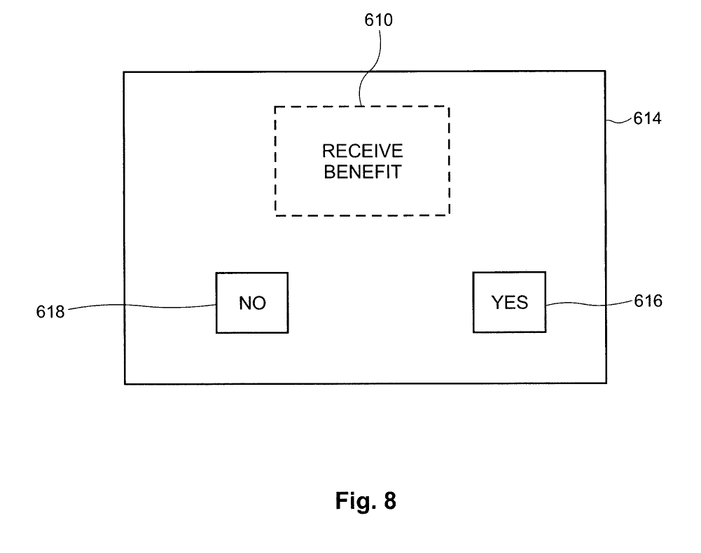

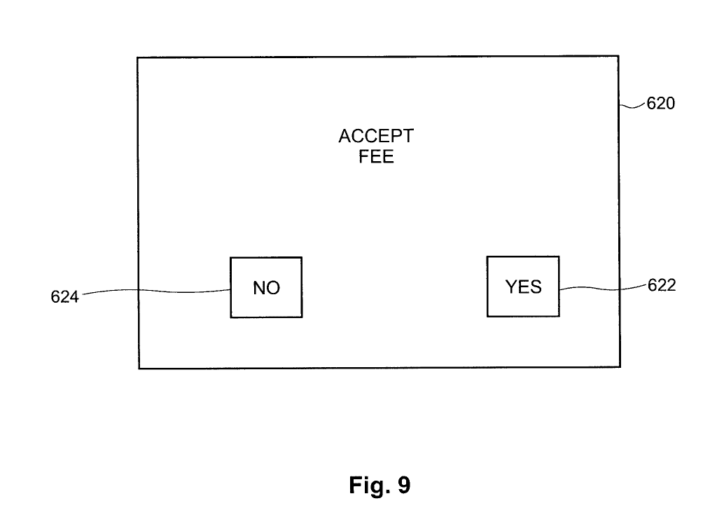

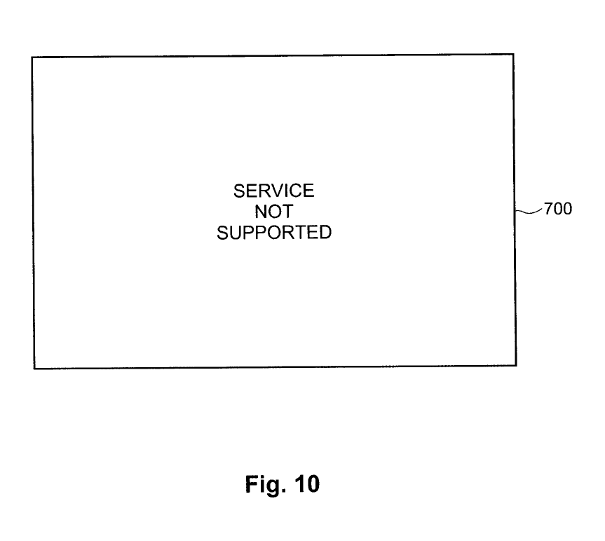

Screen 614 of FIG. 8 may be displayed for example in response to a current user selecting special services option of FIG. 7. Screen 614 may include receive benefit portion 610 which will be displayed to inform or prompt the user with respect to the details of a benefit (e.g., the presentation of the user's pay stub) that is part of the special services feature. If desired, screen 614 of FIG. 8 may include yes/no options 616 and 618 to have the user indicate his or her interest in the benefit described in portion 610. In some instances, there may be a fee associated with receiving the benefit. In such situations, screen 620 of FIG. 9 may be displayed to inform the user of the amount of the fee and to request that the user accept the fee using yes/no options 622 and 624. In some instances, the terminal may not have sufficient capabilities to recognize that the current user has appropriate rights to use the service or that for some reason the service cannot be provided. In those instances, the terminal may display screen 700 of FIG. 10 to inform the current user that the special service is not supported.

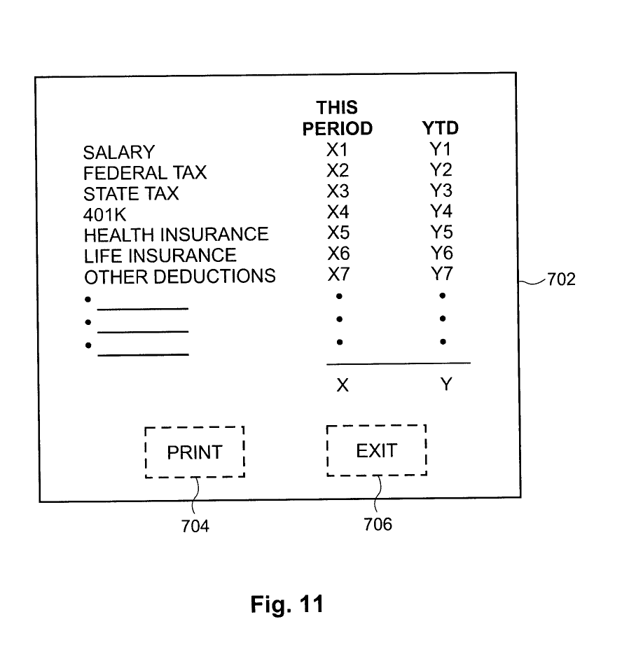

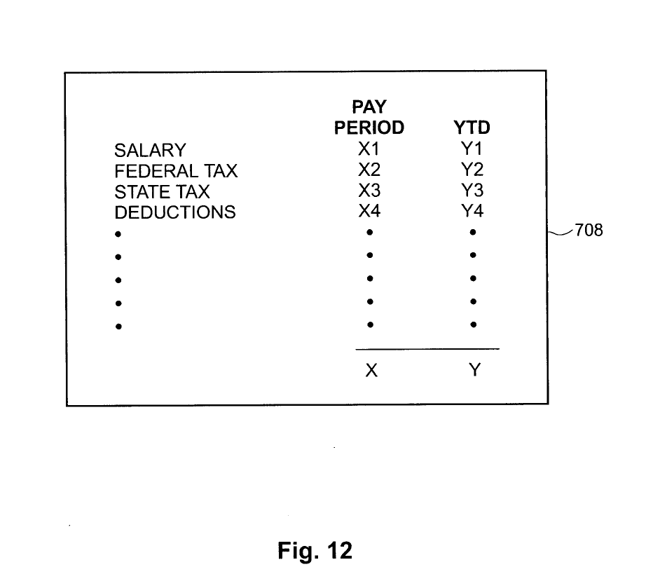

Screen 702 of FIG. 11 illustratively shows a display that can be presented to a current user in response to the user selecting to use the special service option. In the example of FIG. 11, a pay stub service is provided. Screen 702 may contain the details of the current user's pay stub which may have been provided to a message facility (e.g., see FIGS. 1 and 2) to provide such a service. Illustrative types of date fields and formatting for pay stub information is shown in FIG. 11. Screen 702 will thus allow a current user to receive his or her pay stub from practically any location which has a financial services terminal (e.g., an ATM). Screen 702 may include exit option 706 to allow the user to remove the display from view and include print option 704 to have the pay stub information printed (e.g., for the user's records). Printout 708 of FIG. 12 may be presented to the user by a financial services terminal such as an ATM or POS (having an associated printer) to present the user with a printed pay stub or printed pay stub information for the user's benefit. Illustrative content for such a printout is shown in FIG. 12. Information such as salary, withholdings (e.g. federal or state tax), or deductions (e.g., 401K, health insurance, etc.) may be identified and the amount associated with the information expressed. Information that is specific to the current or year-to-date pay period may also be presented. Distinctions between pre-tax and after-tax deductions may also be included.

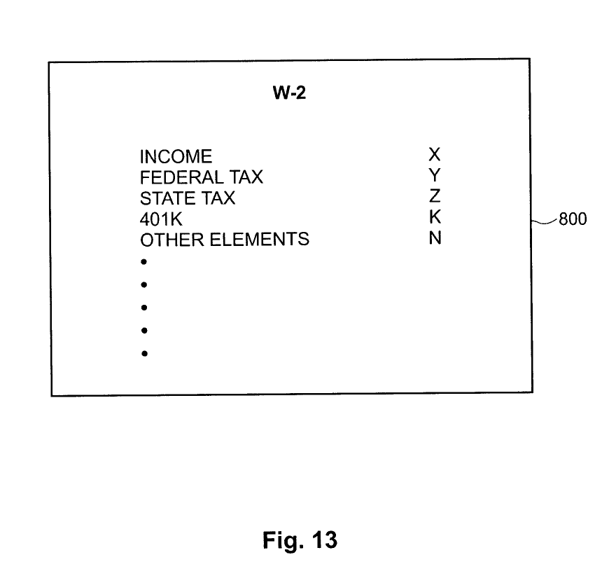

Another service may be a tax document service. Presentation 800 of FIG. 13 may be an example of a benefit that can be provided to a user in such a service. Presentation 800 provides a completed W-2 document to the current user in response to the user selecting the special service, which in this case is the tax document or information delivery service. Information that is less than or more than what would be considered a W-2 or pay stub may also be presented if desired. Presentation 800 may be a printout or a screen display.

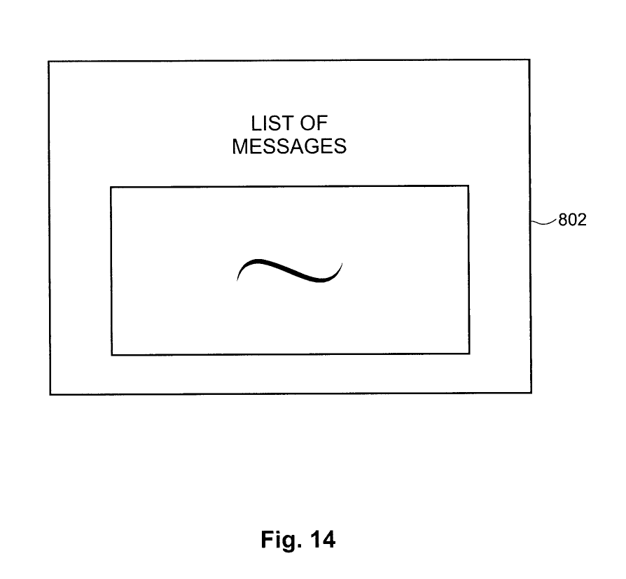

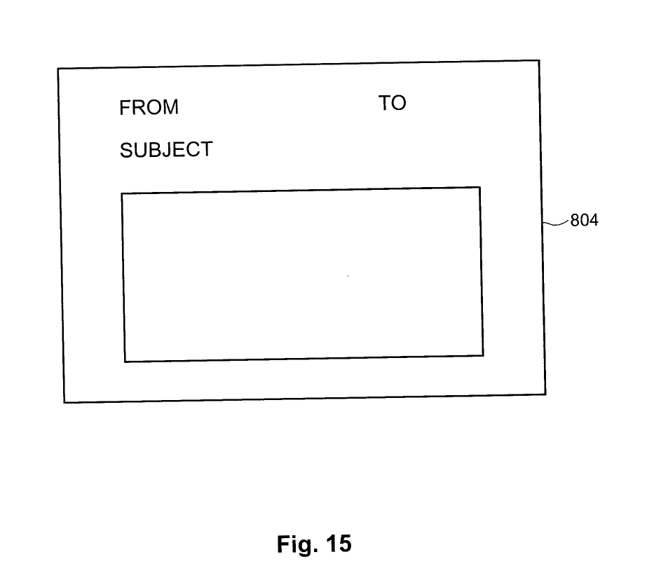

Another special service may be a message service with which users of the financial services network may use the financial service network to provide users with a personal e-mail account or services to receive messages sent by parties other than the financial institution with which the users have their financial accounts. Presentation 802 of FIG. 14 may be presented to a current user of a financial services terminal to provide the user with a benefit of the message service. Presentation 802 may include an identification of a message or an identification of messages in a list. If desired, presentation 802 may be displayed on a screen with user-selectable options for selecting a message. Presentation 804 of FIG. 15 may be presented to a user in response to a user selecting to receive a benefit of the message service such as to view a particular message. Presentation 804 may include message body content and header information (e.g. from, to, subject, date sent, date received, etc.). An object of such techniques being to deliver content from a third party to a current user. One advantage of such a system is that the user does not have to have access to equipment configured to interact with the Internet, does not need access Internet, does not need knowledge of Internet or PC based e-mail applications, etc. The message service could provide automated user authenticated access to their e-mails with very little startup and with a short learning curve.

In general, a financial services terminal may include a processor, a display device, one or more input devices (e.g., a key board, card reader, etc.), memory, communications circuitry (e.g., a modem), a printer, and appropriate software programs. In some circumstances, specific software may be implemented at a financial services terminal, financial institution facilities, and/or messaging facilities to provide the special services. If desired, in instances where a financial services network is already operational to offer financial services, the special services may be provided without the need to implement any changes in the software or hardware of financial services terminals or without the need to implement any changes in the software or hardware of routers in the financial services network. In some instances, the special service may be implemented at a financial services terminal through messaging between end nodes (e.g., a financial services terminal and a messaging facility). The most convenient implementation technique will be one in which financial services terminals offering financial services can provide the special service with little or no change to their permanent hardware or software structure.

If desired, the automated checking of the authorization of a current user may also be considered to be for checking the identity of a current user.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A method for benefiting users of financial services network, comprising:
providing a financial transaction platform comprising a wide area financial services network having numerous dispersed financial services terminals for offering financial services to users;
automatically checking each user for authorization to access the financial services based on access information that was given to the user by a financial institution with which the user has a deposit account or credit account; and presenting a benefit that a third party other than the financial institution seeks to deliver to the user at a financial services terminal at which terminal access information of the user has already been received.

2. The method of claim 1 wherein the providing comprises providing an automated teller machine communications network to be the wide area financial services network.

3. The method of claim 1 wherein the providing comprises providing automated teller machines to be at least some of the financial services terminals.

4. The method of claim 1 wherein the providing comprises providing point-of-sale terminals to be at least some of the financial services terminals.

5. The method of claim 1 the automatically checking of each user authorization comprises receiving access information that comprises account information of a cash deposit account or credit account with a financial institution.

6. The method of claim 1 wherein the automatically checking of each user authorization comprises receiving access information that comprises a personal identification number associated with account information of a cash deposit account or credit account with a financial institution.

7. The method of claim 1 wherein the benefit is a pay stub of the user.

8. The method of claim 1 wherein the benefit is an e-mail that was sent to the user.

9. The method of claim 1 wherein the benefit is a tax document of the user.

10. The method of claim 1 wherein the benefit is not related to financial services.

11. A system for benefiting users of financial services, comprising:
numerous dispersed financial services terminals configured for a financial transaction platform comprising a wide area financial services network having the numerous dispersed financial services terminals for offering financial services to users, wherein each current user is automatically checked for authorization to access the financial services based on access information that was given to the user by a financial institution with which the user has a deposit account or credit account; and
the system is configured to present a benefit that a third party other than the financial institution seeks to deliver to the user at a current one of the financial services terminals at which access information of the user has already been received.

12. The system of claim 10 wherein the wide area financial services network is an automated teller machine communications.

13. The system of claim 10 wherein at least some of the financial services terminals are automated teller machines.

14. The system of claim 10 wherein at least some of the financial services terminals are point-of-sale terminals.

15. The system of claim 10 wherein the system is configured to automatically check authorization of each user by receiving access information that comprises account information of a cash deposit account or credit account with a financial institution.

16. The system of claim 10 wherein the system is configured to automatically check authorization of each user by receiving access information that comprises a personal identification number associated with account information of a cash deposit account or credit account with a financial institution.

17. The system of claim 1 wherein the benefit is a pay stub of the user.

18. The system of claim 1 wherein the benefit is an e-mail that was sent to the user.

19. The system of claim 1 wherein the benefit is a tax document of the user.

20. The system of claim 1 wherein the benefit is not related to financial services.
